(19) United States
(12) Patent Application Publication
(10) Pub. No.: US 2006/0217127 A1
(43) Pub. Date: Sep. 28, 2006

(54) Method and apparatus for finding a mobile radio terminal

(75) Inventors: Christopher Ridgway Drane, Pymble (AU); Malcolm David Macnaughtan, Pymble (AU)

Correspondence Address: MAYER, BROWN, ROWE & MAW LLP, 1909 K STREET, N.W., WASHINGTON, DC, 20006, US

(73) Assignee: Seeker Wireless Pty Limited, Pymble, New South Wales (AU)

(21) Appl. No.: 10/565,440

(22) PCT Filed: Jul. 22, 2004
(86) PCT No.: PCT/AU04/00983

§ 371 Date: Jan. 20, 2006

(30) Foreign Application Priority Data
Jul. 22, 2003 (AU) 2003903789

(51) Int. Cl. H04Q 7/20

(52) U.S. Cl. 455/456.1

(57) ABSTRACT

A method and apparatus for finding a radio terminal (10) in a radio communications network. The method includes making observations of attributes of radio signals associated with the radio terminal (10) and generating a route for a seeker (20) to find the radio terminal (10), based on the observations and estimated error distributions of those observations. The route may be displayed over a topographical map to guide the seeker to the target.

### FIELD OF THE INVENTION

The invention relates to systems or methods for finding a mobile radio terminal.

### BACKGROUND OF THE INVENTION

In the past, many attempts have been made to develop methods of determining the position of a target in a given area. Such applications include determining the location of a military target to direct weaponry to that target, determining the location of a vehicle which has been stolen to enable it to be retrieved and determining the position of a person who has become lost in for example, a wilderness setting.

A vital distinction is maintained throughout the following between on the one hand, the process of locating a mobile radio terminal and on the other hand the process which will be referred to as finding the mobile terminal. In the literature, locating a mobile terminal refers to the process whereby an estimate is made of the position of the mobile terminal. That process is affected by a variety of random errors and therefore the accuracy of such systems is measured in statistical terms which indicate the extent to which such an estimate is likely to vary from the true position of the mobile terminal. By contrast, the process described herein as finding a mobile terminal involves a person moving to the same position as the mobile terminal. The distinction may be understood clearly from the results of the two processes. Upon locating a terminal as described in the literature, one possesses an estimate of the position of the mobile terminal, which could be many hundreds of metres from the true position. Upon finding the terminal however, one has moved to exactly the same position as the terminal. As will be demonstrated later in this section, this distinction can be very significant when comparing the effectiveness of a location system as compared to a homing system for particular applications. For example enabling emergency response personnel to find an injured person in a timely manner.

The prior art contains many examples of homing systems. In the main these are based on radio or acoustic direction finding, in some cases with the use of a secondary indicator for the distance to the target. Such systems operate in a conceptually very simple fashion. The homing device detects a signal from the target device and measures the angle of arrival of the received signal. The user is then advised to move in that direction. As with all radio signal measurements, the initial angle of arrival measurement will exhibit random errors. In principle however, as the homing device is moved towards the target device, repeated measurements enable the trajectory to be adjusted in such a fashion such that eventually the homing device comes to the exact location of the target device. Note that it is not necessary for a direction finding homing device to determine or be informed of its own absolute location or the absolute location of the target device. The device can operate solely in terms of the relative direction between the homing device and target device.

Also existing are location systems for mobile radio terminals. In some of these systems, the mobile terminal receives signals from a plurality of transmitters whose positions are known in order to determine the location of the terminal. Perhaps the best known example of such a system is the Global Positioning System (GPS). Another example is Cursor as described in U.S. Pat. No. 5,045,861. The Cursor system provides a means of locating mobile cellular telephones. The location determination is based on observations by the mobile of the time difference of arrival of signals from the base stations in the network. Both the GPS and Cursor systems involve the mobile terminal measuring the signals received from a plurality of transmitters whose positions are known. Such systems are known as self-positioning systems.

The primary function of a location system is to measure position in absolute terms, for instance within the GPS WGS84 global coordinate frame. The performance of such a system is specified in terms of such concepts as the error radius that includes 67% of the measurements. The performance of a homing system however might be specified in terms of the percentage of times that it enables users to find target devices. A useful homing system will be able to find the target a very high percentage of the time. Of course a radio location system could be used as a homing system, but this requires elaboration of the system, including communication of the estimated position of the target device to the user that is endeavouring to find that device. If the error in the position estimate is large, then the elaborated location system may not provide a method of actually finding the target device with any degree of certainty, and therefore cannot be considered to be a useful homing system. The application of radio location systems for locating mobile telephone subscribers has been an area of great commercial interest since the United States Federal Communications Commission (FCC) mandated that cellular operators provide this capability [FCC96]. The FCC has distinguished between self and remote positioning systems in specifying the required accuracy. For self-positioning systems, the required accuracy is 50 metres 67% of the time and 150 metres, 95% of the time. For remote systems the requirements are 100 metres 67% of the time and 300 metres 95% of the time. It should be noted that these statistical requirements apply on a wide scale, to entire cities for example. In particular areas, for example downtown, the performance could be much worse.

Given that the FCC mandate relates specifically to the task of dispatching emergency response personnel to E-911 callers, there is implicit in the mandate the intention for the positioning systems to be elaborated upon and used as homing systems. It can be seen however that the accuracy requirements in the mandate do not provide the basis for a highly reliable homing capability. For the remote system, for instance, in 5% of the measurements, the estimated position of the mobile may be more than 300 metres from its true position. In an urban area, 300 metres is simply not sufficient to find a lost object or person, especially in an emergency when time is of the essence. Even the accuracy requirements for a self-positioning system fall short of the accuracy needed for an effective homing capability.

The accuracy requirements in the FCC mandate, inadequate as they are for homing, reflect the current limits of technical feasibility for commercial, widely deployable, mobile telephone location systems. These limits are due to characteristics of terrestrial radio propagation including multipath (the arrival of multiple copies of the transmitted signal at the receiver), signal obscuration (commonly referred to in the literature as shadow fading) and near-far interference in which signals from a distant transmitter are blocked at the receiver by the signals from a closer transmitter using the same radio channel. Multipath evidences itself as a bias in the timing observations made by a receiver. The bias is a function of the radio propagation paths between the transmitter and the receiver. This bias translates into errors in the position estimate. The near-far interference and signal obscuration on the other hand result in a smaller number of transmitters being detected by the mobile in a self-positioning system (or a fewer number of receivers detecting the signals transmitted by the mobile in a remote-positioning system). The detection of fewer signals means fewer observations available for determining the location and a corresponding degradation in the accuracy.

In theory of course it might be possible to overcome the accuracy limitations of a location system by making repeated independent measurements and averaging to reduce the error. In practice however the rate of error reduction with this type of averaging may be at best slow due to persistent biases. These persistent biases could, for example, be the result of one or more large buildings in the immediate vicinity whose effect on the observations is not mitigated by repeated measurement. In many cases where the position estimates are biased the average will not converge to the true position at all.

It is therefore an object of the present invention to provide a means for more efficiently finding a target.

### SUMMARY OF THE INVENTION

According to a first aspect of the present invention, there is provided a method for directing a seeker to a target, the method including the steps of:

(a) making one or more observations associated with the target (target observations); and

(b) generating a route based on the one or more observations and estimated error distributions of the one or more target observations.

According to a second aspect of the present invention, there is provided a method for directing a seeker to a target, the method including the steps of:

(a) making one or more observations associated with the target (target observations); and

(b) generating a route based on the one or more observations and estimated error distributions of those target observations to provide likely locations of the target.

According to a third aspect of the present invention, there is provided a method for directing a seeker to a target, the method including the steps of:

(a) making one or more observations associated with the target (target observations);

(b) making one or more observations associated with the seeker (seeker observations); and

(c) generating a route based on a comparison of the one or more target observations and seeker observations and estimated error distributions of those one or more target and seeker observations.

According to a fourth aspect of the present invention, there is provided a method for directing a seeker to a target, the seeker able to receive target observations directly from the target to provide direct target observations, the method including the steps of:
(a) making one or more observations associated with the target (target observations);
(b) making one or more observations associated with the seeker (seeker observations); and
(c) generating a route based on a comparison of the one or more target observations, the one or more seeker observations, the direct target observations and estimated error distributions of the at least one or more target and seeker observations.

According to a fifth aspect of the present invention, there is a homing device for finding a target, the homing device including:

a receiver for receiving signals surrounding the homing device and for measuring at least one selected attribute of those signals to produce homing device observations; and

an output for providing route information to a user to find the target; wherein

the route information is determined by comparing the homing device observations with target observations derived from measuring at least one selected attributes of signals associated with the target and estimated error distribution of the at least one measured selected attribute of the signals associated with the target.

According to a sixth aspect of the present invention, there is provided a method for directing a seeker to a target, the method including the steps of:
(a) calculating at least one probable location of the target; and
(b) generating a route to direct the seeker to a most probable of the at least one probable locations.

### BRIEF DESCRIPTION OF THE DRAWINGS

The preferred embodiment of the present invention will now be described with reference to the following drawings, in which:

FIG. 1—shows a first arrangement of elements in a network according to the present invention;

FIG. 2—shows a second arrangement of elements in a network according to the present invention;

FIG. 3—shows a third arrangement of elements in a network according to the present invention;

FIG. 4—shows a general arrangement of elements in a network according to the present invention;

FIG. 5—shows the main elements of a homing device according to a first embodiment of the present invention;

FIG. 6—shows the main elements of a target device according to a first embodiment of the present invention;

FIG. 7—shows a sequence of steps used in the method according to the first aspect of the present invention;

FIG. 8—shows a probability distribution for finding a target, overlaid on a street topography;

FIG. 9—shows the main elements of a homing device according to an alternative embodiment of the present invention; and

FIG. 10—shows a sequence of steps used in an alternative method of the present invention.

### DETAILED DESCRIPTION OF THE PREFERRED EMBODIMENT

In the following description, the homing system refers to the combination of the processing means for estimating relative position, selecting search routes, etc. and the homing device. The homing device refers to the device carried by the user through which the system communicates with the user. On occasions, the term “seeker” may be used, which may refer to the homing device itself or a User of the homing device, or the combination of the User and the homing device.

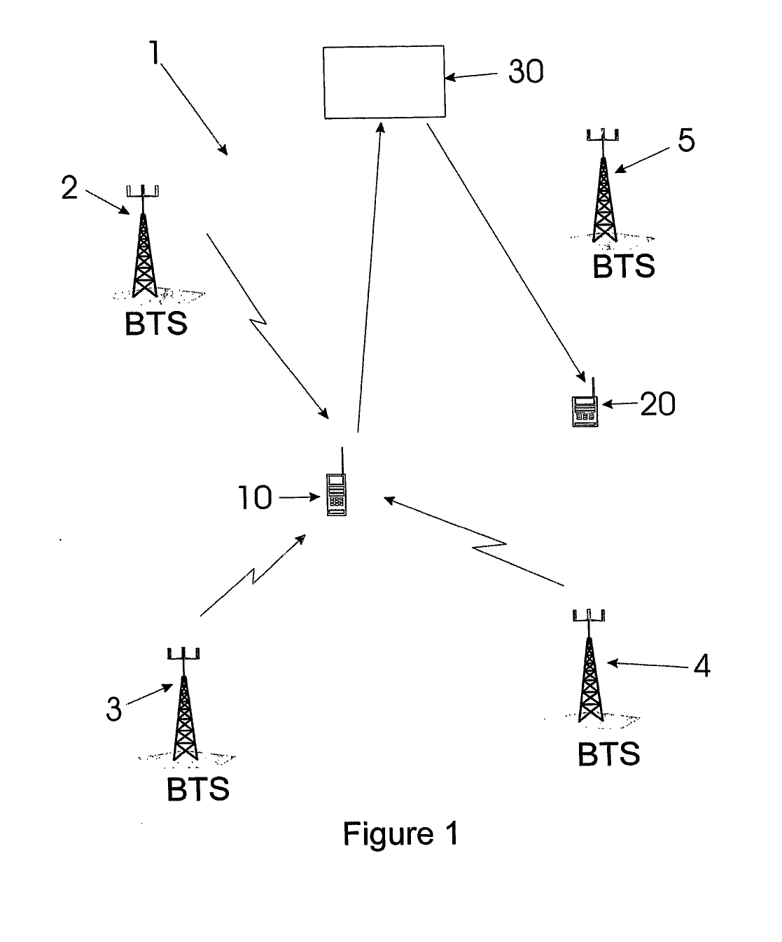

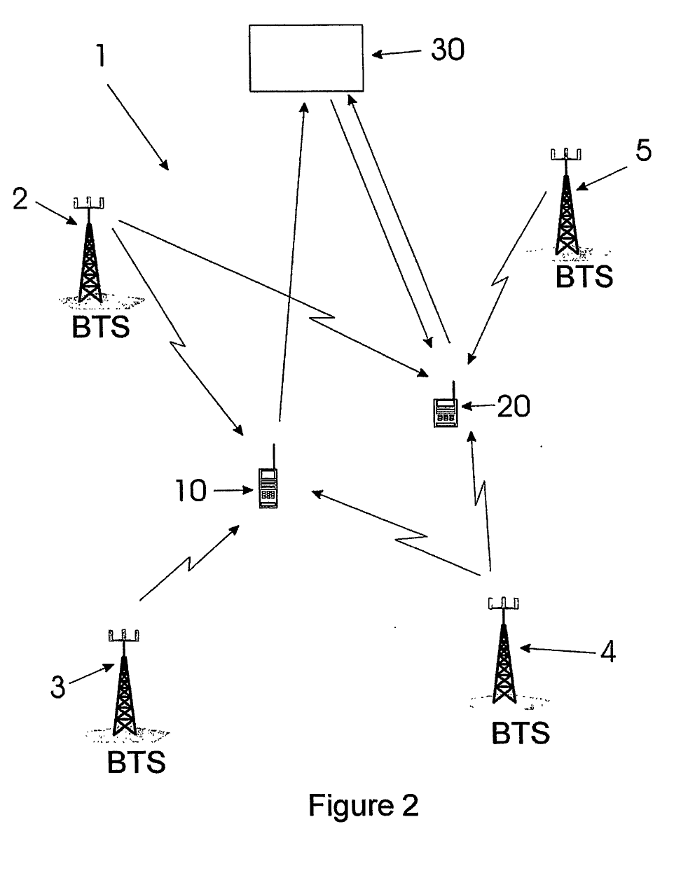

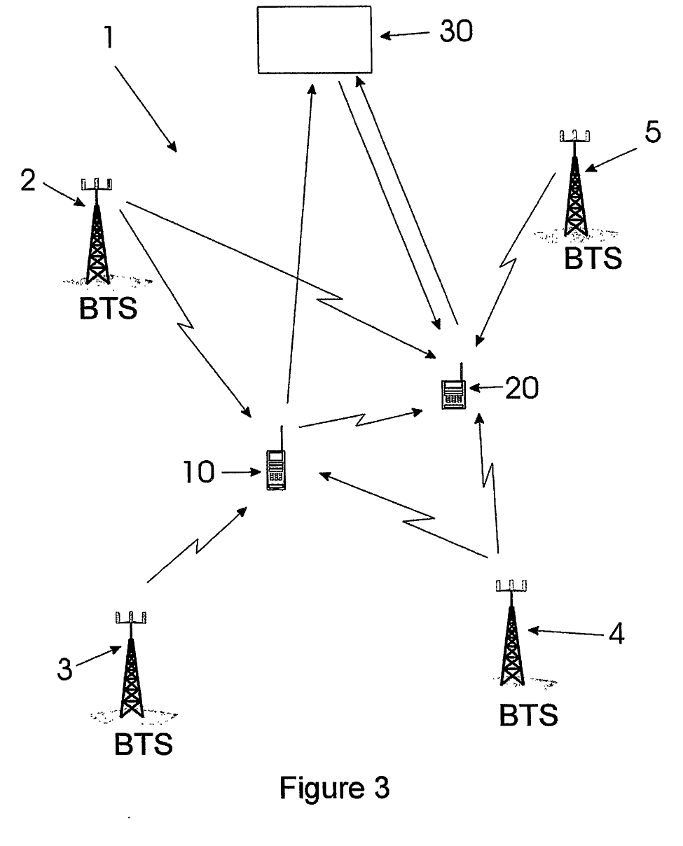

In the following paragraphs a series of methods are disclosed which can be used to implement an effective system for homing in on a mobile radio terminal. These methods can be applied in different combinations depending on the nature of the application and the technical and economic constraints that affect that application. To aid in understanding the different methods and the circumstances under which they could be used, the possible homing applications are arranged into three groups according to the capabilities provided by the target and homing devices respectively:
1. Target device measures selected attributes of radio signals and reports these to the homing system but homing device has no separate signal measurement capability.
   This arrangement is illustrated in FIG. 1, in which target device 10 is shown within mobile telephone network 1 including BTS units 2, 3, 4 and 5. Target device 10 is able to make measurements of signals within the network and report these to homing system 30. Homing device 20 is unable to, or incapable of, taking measurements of surrounding signals. Homing system 30 communicates directly with homing device 20.
   Note that while the preferred embodiment has Target device 10 making its own measurements of its surroundings, it is conceivable that other devices make the measurements of signals transmitted by Target 10, and report these to the homing system 30. Alternatively the measurements may be made by both the target and one or more external devices.
2. Both target and homing devices measure selected attributes of radio signals and report these to the homing system.
   This arrangement is illustrated in FIG. 2 in which target device 10 is in mobile phone network 1 including BTS units 2, 3, 4 and 5. Target device 10 is able to take measurements of surrounding signals and reports these to homing system 30. In this configuration, homing device 20 is also able to make measurements of surrounding signals and report these to homing system 30.
   Again, while it is preferable for the homing device 20 to take its own surrounding measurements, it is conceivable that other devices take the measurements of the signals transmitted by homing device 20 and report these accordingly.
3. Target and homing devices measure selected attributes of radio signals in their vicinity and report these to the homing system. In addition, the homing device directly measures selected attributes of signals transmitted by the target device and supplies these to the homing system.
   This arrangement is illustrated in FIG. 3 in which target device 10 is in mobile communications network indicated generally by 1, which includes BTS units 2, 3, 4 and 5. Target device 10 is able to take measurements of signals surrounding it and report the results of these measurements to homing system 30. Similarly, homing device 20 is able to take measurements of signals surrounding it, and report these to homing system 30. Additionally, homing unit 20 is able to receive and process signals transmitted by target device 10. Optionally, homing device 20 may act as a relay between target device 10 and homing system 30 such that it can relay the received transmissions from target device 10 to homing system 30 rather than target device 10 transmitting its information directly to homing system 30.

In general, the homing process can be conceived of as having two stages:

a searching stage and a tracking stage.

The searching stage applies in cases where the target and homing devices are unable to report sufficient common observations, i.e. observations of the same signals to enable their relative position to be measured directly. During this stage methods are used that enable the homing user to perform an efficient search for the target, with the aim of reducing the separation between homing and target devices to the point that sufficient common measurements can be made. Once sufficient common observations are available, the homing system enters the tracking process using the differences between common sets of observations to enable the homing device to converge more rapidly to the position of the target. Note that the search, if sufficiently exhaustive, can result in a successful finding of the target without the necessity of using the tracking stage. The aim however, is to achieve the most efficient search possible.

The system provides a mobile terminal (the target device) 10 that is able to measure selected attributes of signals received from geographically dispersed network terminals of the network serving that mobile terminal. (These network terminals may or may not be fixed in their position, however it is assumed that their position at any given time is accurately known). These measurements will hereafter be referred to as observations. The target device 10 reports the observations to the homing system 30. As an example, the mobile terminal 10 could be a cellular mobile telephone. In that case the network terminals would be the base stations (2 to 5) of a cellular mobile network 10 as shown in FIGS. 1 to 3. Alternatively the mobile terminal could be a wireless LAN adapter. In that case the network terminals would be the fixed Wireless Access Points. It is assumed that the location of the network terminals are available to the homing system. It is further assumed that when the mobile terminal 10 reports an observation pertaining to a particular network terminal it also supplies information enabling the homing system 30 to identify that terminal (in order to use the information concerning its location). For example in the cellular network case, parameters identifying the base station would be supplied along with any observation.

In the scenario of FIG. 1, the fact that the homing device 20 does not have the capability to make measurements means that only searching methods can be applied. The homing system 30 first uses a standard technique to decide if the target 10 is moving or not. If the target 10 is moving, the homing system 30 is able to gather independent observations over a range of positions, filtering them to reduce spatially uncorrelated biases in the observations (for example multipath biases). Such a set might be sufficiently accurate that the homing device 20 can provide directions enabling a user of the homing device 20 to follow a route that will intercept the target 10. More often, the accuracy will be sufficient to be able to follow the progress of the target, allowing the user to wait until the target 10 has stopped moving. There are strong public safety reasons for waiting until the target is stationary before trying to intercept it.

In some arrangements (as will be discussed in more detail below), it is possible for the user to provide the homing device with information as to the mobility of the target 10.

In the case when the target is stationary, (which in environments that give rise to heavily biased location estimates makes the target more difficult to find), the following strategy is employed. The homing system 30 uses the observations reported by the target device 10 to estimate the most likely locations for the device (for example by calculating the probability density function (p.d.f.) for the location of the target device). This p.d.f. could be continuous but for ease of explanation we will assume it is in the form of a list of likely positions and associated probability values representing the likelihood that the target device 10 is at the respective positions. The homing system 30 then plans a route, that visits the most likely locations of the target first, but then visits increasingly less likely locations (taking into account the street topography). The route is communicated to the user of the homing device, by standard means, such as synthesized voice, text, or image. The user then travels the route looking for audio or visual signs of the target 10. By first visiting the most likely locations, the user of the homing device is likely to find the target in the most efficient manner. However, by following an exhaustive planned route, the user of the homing device will eventually find the target.

According to an aspect of the present invention, the user interface need not indicate a position for the target, but rather a route to be taken to find the target. This form of interface will cause less frustration on the part of the user than an interface that presents a list of possible positions. This will in turn make it more likely that the user will follow an exhaustive search process and thereby succeed in finding the target device. The route planning process could optimise the route for such factors as street topography and geographical relationship of the likely positions. For example the distances between the possible positions and the associated probabilities of the target 10 being at those positions could be used to select the route with the lowest expected distance.

It can be seen that an aspect of this invention is the observation of signal characteristics related to the path (primarily the distance) between geographically dispersed terminals (2-5) of the radio network whose positions are known and a target mobile terminal 10. Accordingly, this invention also applies to mobile terminals that are equipped with GPS receivers that make observations of the time of arrival of signals from satellites. Similarly it also applies to remote positioning systems that make observations of the signals transmitted by the mobile using remote terrestrial based receivers for example.

In some cases the homing system 30 could be designed to perform relative position calculations and route selection etc. at an intermediate point and merely use the homing device 20 as a means for communicating with the homing user. In this case the user may not even need a dedicated homing device but instead could use some other general purpose communications device to receive the directions. This could mean for instance that police requiring a homing capability could have the directions communicated via the existing police radio network thereby significantly reducing deployment costs.

As described above, the homing system 30 in this aspect enables the user to move to the position of the target. The homing system 30 will calculate a set of likely positions of the target 10, and provide directions to the user specifying an efficient search route. This route could be specified in a variety of terms depending on the capabilities of the homing device 20 in particular whether the homing device has an independent positioning capability or not. For the case where the homing device does have an independent positioning capability (for instance a GPS receiver), the directions for the user of the homing device 20 could be presented simply in the form of a relative direction in which to move (for instance an arrow on a screen also relying on the ability of the GPS receiver to detect current direction of movement). The directions could also be automatically updated as the user moves. However, a simpler alternative is also viable. In this case the instructions could be presented to the user step by step in terms of local landmarks such as street names etc. The user could be asked to orient the device with respect to a particular street. The homing system 30 would rely on the user to indicate when a particular step had been completed. This would be suitable for instance for people using the homing system in an area where they were familiar with the local geography. One such application could be searching the streets surrounding one's home for a missing child or pet. The ability of the system to operate without requiring a positioning capability in the homing device would enable the cost of the homing device to be much lower and perhaps more in accord with the cost one might be prepared to pay for a device for occasional application such as finding a lost pet.

Turning now to the scenario of FIG. 2 which includes all the elements of the first aspect, the homing device 20 is now also equipped with a receiver capable of measuring the same types of network signal attributes as the target device 10. The homing system 30 can use this additional information in a number of ways. In particular it enables the homing system 30 to move from a search mode of operation to a tracking mode when there are sufficient common observations reported by the homing 20 and target 10 devices. This tracking mode can involve direct calculation of the relative positions of the homing and target devices. In the presence of common mode errors, this enables a more accurate computation of the relative positions than separately calculating the location of the target and homing devices and differencing the result. This process of measuring the relative positions using common observations is a feature of this aspect of the invention in the scenario of FIG. 2. In addition to the potential for accuracy improvement, the ability to compute relative position directly from a common set of observations enables the system to operate even in unsynchronised radio networks without requiring the use of pseudo-synchronising methods. Indeed this also means the homing system can operate effectively with fewer network terminals than is needed by methods and systems of the prior art, for example as that described in U.S. Pat. No. 6,529,165.

This aspect of the invention could also operate if the target and the homing device were equipped with GPS receivers whereby the GPS signal observations from the target and homing devices are provided to the homing system. (Note that the GPS receivers are being used to report timing observations, not to solve for position). It could also apply to a remote positioning system, in which case the homing device would be equipped with a mobile telephone transmitter that could be observed by the geographically dispersed receivers of the remote positioning system.

As discussed with reference to the first aspect above, the homing system could also be designed to have the signal observations communicated to an intermediate point, all the calculations done at the intermediate point, and then the relevant navigation information communicated to the homing device.

A further feature of the present aspect is the provision of a means for the homing device 20 to send a data message to the target device 10 specifying a series of radio channels for the target device to measure. This enables the homing system 30 to focus the measurement resources of the target device 10 on the radio signals that can be heard by the homing device 20 thereby increasing the degree of commonality in the two resulting sets of observations.

Alternatively, the homing system 30 could instruct the homing device 20 to measure the same signals as are being measured by target device 10, and being reported to homing system 30.

There would also be a provision for the target device to indicate the radio network channel parameters to the homing device, enabling that device to detect the signals. These channel parameters could include frequency, timeslot, serving network access point identifier and code. The advantage of a mechanism whereby the homing device directly measures the signal transmitted by the target device is that the accuracy of these measurements in positional terms increases rapidly as the homing device closes on the target device, providing an extra, highly accurate source of positional information, enabling even more rapid convergence of the homing system.

Of course this facility will be much more easily implemented in radio networks where there is no duplex separation between terminal transmit and receive frequency bands. Examples include a UMTS network operating in TDD mode and a TD-SCDMA network. However in other cases technical and economic factors could also make the addition of this capability to the homing device useful.

A further improvement of this aspect would be to include a direction finding antenna in the homing device. In cases where line of sight propagation was possible between the target device and the homing device, the direction finding antenna could be used in a standard way to facilitate a very rapid convergence on the target.

In the case where the homing device is able to measure the time of arrival of the direct signal from the target, then a further enhancement to this aspect is possible. The enhancement assumes that both the homing device and the target device is able to measure the round trip time to the same BTS. This information could be sent to homing system 30 to calculate the various range information used below. Of course it will be understood that the homing device 20 could have its own computational abilities. If the timing advance of the target is communicated to the homing device by a standard communications means (e.g. SMS), then it is possible to work out the range from the homing device to the target, the homing device to the common BTS, and the range of the target device to the common BTS. This provides the three sides of a triangle, or sufficient information to make a radial-radial location measurement when the position of the homing device is known. This measurement does not provide an absolute position fix, but does provide the relative location of the target. This relative location measurement will increase in accuracy as the homing device moves closer to the target. The relative location can be used in a similar fashion to the direction finding antenna to indicate the relative angle to the target (and also the range). In order to use this relative angle information, the User will need to be provided with an orientation, for example by a compass or by asking the user to align the homing device with a particular street.

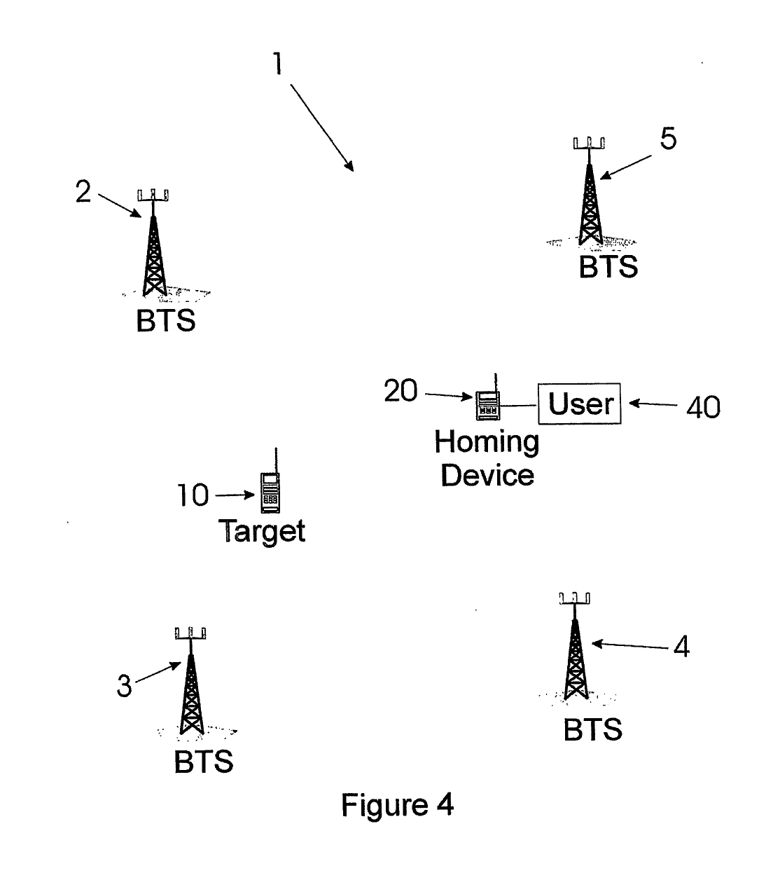

A particular example of this aspect of the invention applied to a mobile telephone network whereby a user 40 of the homing system 30 is able to find a mobile telephone is shown in FIG. 4. FIG. 4 depicts a segment of a mobile telephone network 1 which includes a number of geographically dispersed BTSs, 1, 2, 3, 4 and 5. There could be more or fewer BTSs. Also shown are a homing device 20 and a target device 10, being the mobile telephone in this case. The homing and target devices are able to exchange data via the mobile telephone network, 1. Note that although the BTSs 2, 3, 4 and 5 are typically considered part of the mobile telephone network, 1 is shown in order to represent the additional components of the mobile telephone network required to provide a communications facility between the homing and target devices. This exchange could be via a short message service (SMS) or other data exchange protocol supported by the network for instance a packet based data communication service supported by the network. The homing device is in the possession of a User 40 who is seeking to find the target device 10, travelling either on foot or via some other means of transport.

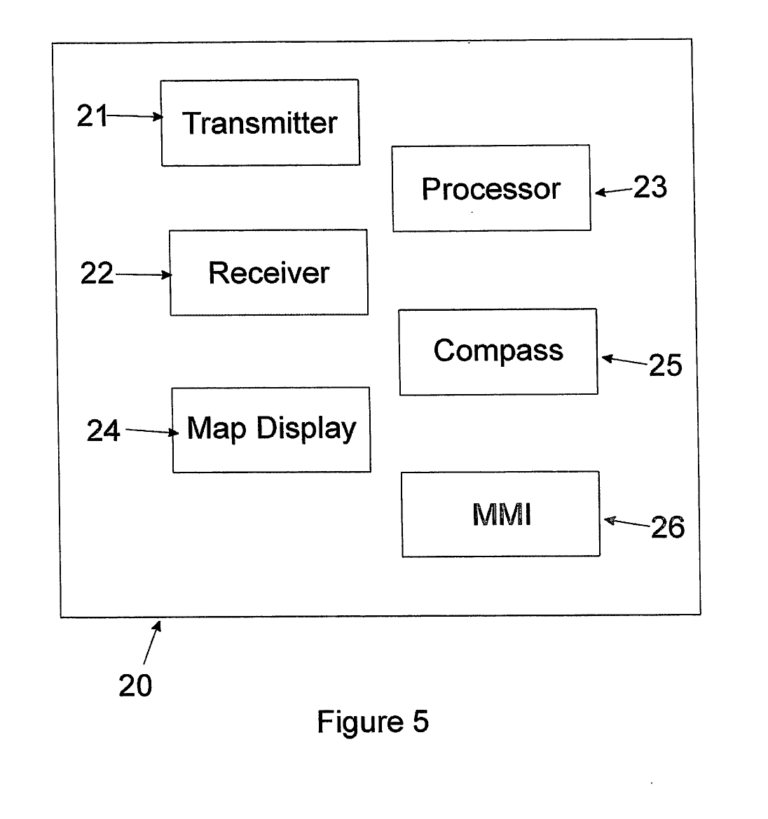

The main elements of the homing device 20 are shown in FIG. 5. It includes a standard mobile telephone Transmitter, 21, a mobile telephone Receiver, 22 that has been enhanced in order to make, upon demand, accurate measurements including received signal levels and timings for the broadcast channels of all BTSs that it can detect within its neighbourhood. The accuracy with which the receiver is able to measure the signal timings is of the order required for GSM E-OTD measurements as specified in Annex I of ETSI. GSM 05.05: “digital cellular telecommunication system (phase 2+); radio transmission and reception, 2001 which is hereby incorporated by reference. The measurement reports would include information identifying the BTS corresponding to each measurement. For a GSM network for instance, this would be either the full Cell Id or alternatively the Short-Id. The receiver also provides the capability to optionally perform measurements on a specified list of radio channels. These channels could be specified in a message received from the homing device along with other measurement description parameters. The enhancements to the receiver could be in accord with those required to support a standard location system such as the Global System Mobile (GSM), Enhanced-Observed Time Difference (E-OTD). Alternatively the modification could be special purpose. The homing device 20 also includes a general purpose computer or processor, 23, such as is commonly found in mobile telephones. The homing device could also include a display, 24, capable of presenting a map image. This map display is not essential, however it would provide a convenient means to convey route guidance information to the user. It should be noted that the map display would be implemented as a digital map displayed on a standard graphical screen. Accordingly the map display could also be used to convey other information to the user, such as an arrow indicating compass heading. A further optional element of the homing device 20 would be a compass, 25. Such a compass could be of solid state construction, providing a small and cost effective implementation. This compass would enable a map display to be optionally oriented correctly with respect to the ground, aligned with true north regardless of the orientation in which the user rotated the device. Such a compass would also enable relative bearing indications for the target to be presented consistently irrespective of rotation of the device by the user. The homing device also includes a man machine interface (MMI) 26 such as commonly provided in mobile telephones which enables the user to optionally input information concerning the likely mobility of the target device.

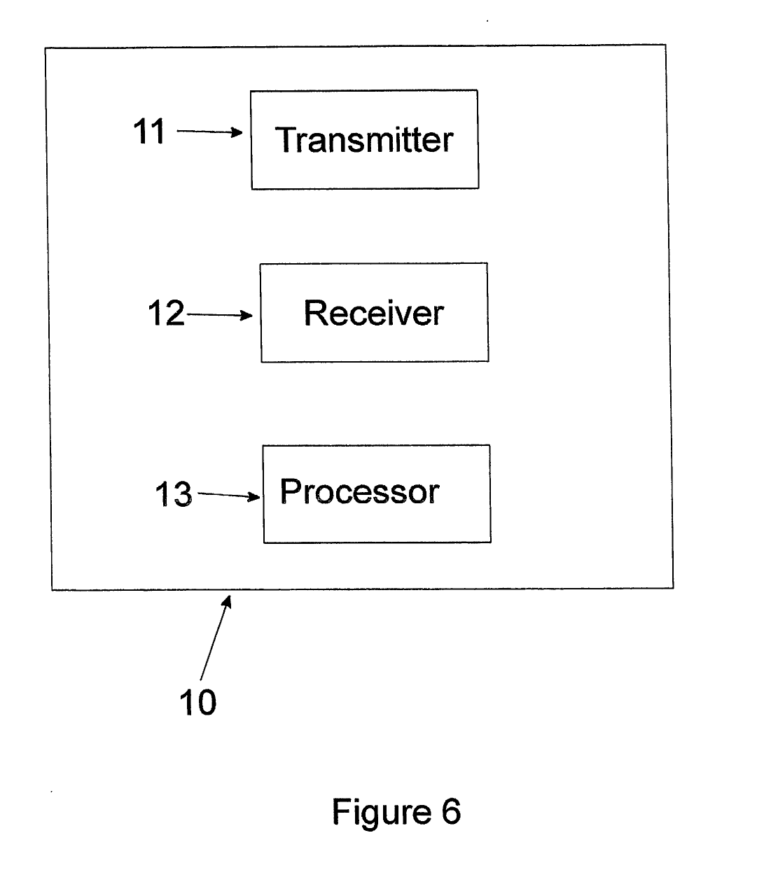

The main elements of the target device 10 are shown in FIG. 6. It contains a standard mobile telephone transmitter, 11, a mobile telephone receiver, 12, that has optionally been modified in a similar fashion to the mobile telephone receiver 22 in the homing device 20 and a processor 36.

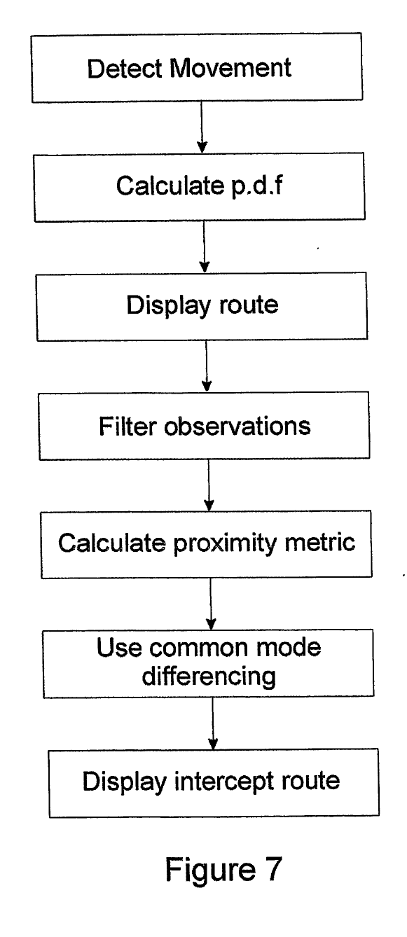

The steps used in the method for the homing device 20 to find the target device are shown in FIG. 7.

Detect Movement The Homing Device processor 23 (refer to FIG. 5) receives measurements of the received signal timings and signal strengths (the observations) measured by the target device receiver, 12. The Homing Device processor 23 can determine if the target device 10 is moving using techniques well known to those skilled in the art. For example it could inspect the sum of squared differences between observations made at two different time periods and use a statistical test to determine if there is a significant change. If movement is detected, then the method would proceed to step “Display Intercept Route”, otherwise it assumes the target is effectively stationary and goes to the next step to calculate p.d.f. Alternatively if the user of the homing device 20 has specified that the homing system 30 should treat the target device 10 as stationary, the method would start at the calculate p.d.f. which is the start of the search strategy.

Calculate p.d.f. The homing system 30 will receive timing and signal strength measurements from the target device, 10. If the network is synchronised or the offsets are known (as could be done with the method described in U.S. Pat. No. 6,529,165 B1 or by the E-OTD standard), then it is possible to calculate an estimate of the target device position based on the timing measurements. Using known methods, it is possible to estimate the p.d.f. for the position estimate. For example, a method with only a small computation load would be used to calculate the error ellipses, assuming that the errors are Gaussian and the position equations can be linearised near the true position of the target device 10. A more accurate technique would involve the use of a bootstrap method as described in A. M. Zoubir and B. Boashash—The bootstrap and its application in signal processing, IEEE Signal Processing Magazine, 15(1):56-76, January 1998, the contents of which is hereby incorporated by reference. This could involve a technique such as selecting random quartuplets of common timing observations from the set of all available observations. Each quartuplet can be used to calculate a unique position estimate. The sample distribution of these quartuplets will give an indication of p.d.f. of the target device position. This p.d.f. can be discretised to yield a list of possible positions, with corresponding probabilities.

If the network is not synchronised and the base station timing offsets are not known, the signal strength measurements can be used to make a less accurate estimate of the target device position. Several methods are described in the open literature for making such measurements, for example Martin Hellebrandt, Rudolf Mathar and Scheibenbogen Markus—Estimating position and velocity of mobiles in a cellular radio network, IEEE Transactions on Vehicular Technology, 46(1):65-71, February 1997, the contents of which are hereby incorporated by reference. This type of method is commonly referred to as a Cell-ID or Network Measurement Results (NMR) positioning method. Error ellipses and a modified bootstrap method can also be used to calculate the p.d.f. in this case.

An example of an algorithm that may be used to calculate the route will now be discussed.

This algorithm develops a search route in a particular region, with the aim of finding the target. The aim of the algorithm is to generate a route that has the minimum expected time to find the target. The following is a heuristic algorithm that should approach this objective:
Based on the observations, generate a probability density function (p.d.f.) for the location of the target. There are a number of ways this can be done.
   One approach would be to calculate the covariance matrix for the measurements [J′V⁻¹J]⁻¹ where V is the covariance matrix of the observations. If the errors are gaussian, then the standard equation for a multi-dimensional gaussian p.d.f. can be used. In this case the contours of constant probability will be ellipses.
   The covariance matrix approach assumes that the errors are gaussian distributed. An alternative approach, that does not make this assumption is to use bootstrapping resampling in order to generate an estimate of the p.d.f.
Once the p.d.f. has been derived, then the p.d.f. can be overlayed onto a street map of the region of interest. Transform this map into a set of vertices and edges, with the streets corresponding to edges, and the intersections will be vertices. For each edge, integrate the estimated p.d.f. over the adjacent region in order to assign a probability to that vertice. The adjacent region can be defined in a number of ways but would consist of a simple portion of the area. For example if the region only had parallel roads that were 1000 metres long, and were 50 metres apart, then the integration region for each edge (street) would be a rectangle 50 metres wide, centred on the street, and 1000 metres long.
The problem has now been refined to finding a route along a set of vertices and edges, with a probability assigned to each edge. This problem formulation is suited to analysis by graph theory.

This aspect of the homing system provides for an efficient route for the seeker that will result in the shortest expected time to locate the target. The procedure just described is used when the Detect Movement step determines no movement. In the case however, when movement is detected, consideration must be given to the rate at which the target 10 is moving. For very slow rates, it is unlikely that the system would be able to detect the movement and therefore it would operate as for the non-moving case.

In the event that the data indicate that the target is moving (and therefore at some speed) it is no longer possible to offer a route for the seeker that will converge with the target. This is because it cannot be assumed that the velocity of the target will remain constant and also because to guarantee convergence, the seeker would have to be capable of maintaining a faster speed than the target—something the homing system cannot rely on in attempting to compute such a route. Therefore in this circumstance, the homing system will inform the seeker that the target has been detected to be moving and rather than providing a detailed search route, will offer a simple route that leads toward the likely location of the target. The idea is that the seeker should move towards the current vicinity of the target in order to resume homing as soon as the target has slowed sufficiently. In the event that the seeker comes sufficiently close to the target for the system to commence tracking processing then the operation would be modified accordingly.

Display Route Based on the p.d.f. calculated previously, it is possible to determine a route that will visit the most likely locations of the target first, and then progressively move to less and less likely locations. A simple example of such a route would start at the most probable position, and then move outwards in concentric ellipses, having regard to the pattern of the streets. This route information could be displayed on the map display, 24 of the homing device, 20. It could also be provided to the user by textual or audio messages.

Filter Observations Whilst the homing device 20 moves, the observations can be filtered using a method that accounts for movement. Such filters are well known to those skilled in the art. An example is the Kalman filter. This filtering provides a more accurate estimate of the timing and signal strength. The observations from the target device, 10, can be filtered in a similar fashion, in this case taking into account the decision made in the Detect Movement step concerning the mobility of the target device. Whilst carrying out this step, the user, of the homing device, 20 is assumed to be progressing along the route defined in this step.

If the homing device 20 has an independent positioning capability then the absolute positions inferred by the relative position estimates can be averaged. If the homing device moves over a wide area, this should improve the accuracy of the resulting estimates.

Calculate Proximity Metric The calculation of the proximity metric will only include observations of the BTSs that are reported by both the homing device 20 and the target device 10. This subset of the observations will be referred to as the in-common subset. For example, if a particular BTS is observed by the homing device 20 but not the target device 10, then the measurements by the homing device of that BTS would not be included in the in-common subset. The proximity metric could take a number of forms. The simplest would be the weighted sum of squares between the filtered estimates of timing and signal strength from the homing device 20 and the filtered estimates of timing and signal strength from the target 10, divided by the number of BTSs in the in-common subset. The weighting would take into account the estimates of the variability of each of the observations.

More sophisticated versions of this metric are possible. For example, if N is equal to the number of BTSs in the in-common subset, then instead of dividing by the weighted sum of squares by N, it would be possible to divide by a non-linear function of N. The non-linear function would be chosen to increasingly reduce the size of the metric as the number of BTSs in the in-common subset increases. Such a function would be N². This non-linearity is based on the obvious phenomenon that as the homing and target devices move closer to each other they are increasingly likely to detect the same BTSs.

If the proximity metric indicates that the target device 10 and the homing device 20 are close to each other, then the method would enter tracking mode by the use of the Common Mode Differencing step otherwise the method would use the filter observations step.

Use Common Mode Differencing Once it is determined that the homing device 20 and target device 10 are close to each other, then it becomes possible to more accurately calculate the relative position. This is due in part to the possibility for eliminating common mode errors in the homing and target device observations, particularly relating to multipath biases. In the GPS prior art, several methods are disclosed for calculating the relative position in such a situation, some of which would be applicable to this situation. The simplest method is to continuously make position estimates using the observations from the homing device but limit the observations to the in-common subset. Similarly a position estimate can be made using the observations from the target device 10 using only the in-common subset. The relative position is calculated by taking the vector difference between the two position estimates. Alternatively the relative position can be calculated directly which can require a smaller number of network terminals.

Because the common mode differencing is able to provide a more accurate relative position determination, the user may be instructed to abandon the pre-determined route, and follow a direction or new route indicated by the relative location from the homing device to the target device. This modified set of directions could be indicated on the map display, 24 (see FIG. 5), or given as audio or visual cues via the MMI 26. If the homing device includes a compass, 25, the direction could be provided in terms of a suitable indicator on the map display, whose orientation is adjusted according to the relative bearing to the target device 10 and the orientation of the homing device display 24 at the time.

The proximity metric can be re-calculated at suitable intervals to monitor the progress of the homing device 20 towards the target device 10. If the proximity metric indicates that the homing device and the target device are diverging, then the user can be directed back to the predefined route (or a suitably modified version of the predefined route), and the method recommences with the Filter Observations step.

If the proximity metric continues to indicate that the target and homing device are converging, then the method continues with this current step. As the homing device 20 continues to approach the target device 10, an audible or visual indication of the estimated distance to the target could optionally be provided to the user. As this process continues, the relative position measurements become increasingly accurate, and eventually the user of the homing device 20 establishes visual contact with the target device 10 and the method is considered complete.

An example of how the above can be calculated is now considered in more detail.

It is assumed that both the homing device 20 and the target 10 have a set of observations associated with them. Suppose that there are a subset of these that are shared. For example, the homing device 20 might have signal strength and timing measurements for the first, second, and third BTS, whilst the target 10 might have signal strength and timing measurements for the first and second BTS. Accordingly, the observations for the first and second BTS are in-common. Suppose there are N observations in common. Denote the target's N in-common observations as xi_{T}=(ξ_{T1}, . . . ,ξ_{TN})′, and the horning device's in-common observations as xi_{H}=(ξ_{S1}, . . . , ξ_{SN})′ where (.)′ denotes transpose.

If the homing device and the target device are close to each other, an observation equation for the Target would be
ξ_{T}=g(x_{T})+d+n_{T} (1)
where x_{T}=(x_{T},y_{T},ε_{T})′ is a parameter vector denoting the (xy) position and timing offset (E). The vector function, g(•) maps the parameter vector to the observations, d are common mode errors (common to both the horning device and target), n_{T} is the noise components associated with the target that are not in-common with the homing device. Note that for certain location methods, it may not be necessary to include the ε parameter (e.g. systems relying only on signal strength).

Similarly, for the homing device, we can write
ζ_{H}=g(x_{H})+d+n_{H} (2)
where x_{H} is the parameter vector of the homing device, n_{H} are the noise components associated with the homing device that are not in-common with the target. Denote the offset between the homing device and the Target as δx, i.e. δx=x_{T}−x_{H}.

The most common way to estimate the offset is as follows
\acute{δ}x=g⁻¹(ζ_{T})−g⁻¹(ζ_{H})=g₋₁(g(x_{T})+d+n_{T})−g⁻¹(g(X_{H})+d+n_{H}) (3)

However, this does not eliminate the common mode errors, and also does not provide gradual convergence on the target. Instead, it is proposed to calculate the offset as follows: [symbol]
=h(ζ_{T}−ζ_{H})=h(g(x_{T})+n_{T}−g(X_{H})+n_{H}) (4)
where h is some suitable inverse function. Using this approach, the common mode errors are eliminated. There is no general solution to finding the function h, however the following approach is useful when no such general inverse function can be identified.

If the δx, δy are small, then we have, using standard differential geometry, that
δζ≃Jδx, (5)
where δζ denotes a small change in the observations, and J is the Jacobian matrix given by

$${[ J ]}_{ij} = \frac{{δ}_{y :} ( {x}_{1} , … , {x}_{N} )}{{δ}_{xy}} \qquad ( 6 )$$

The general solution to this equation can be written as [symbol]
≃J^{†}(ζ_{T}−ζ_{H}), (7)
where (•)^{†} denotes the Moore-Penrose Inverse. In the case where equation 5 is overdetermined, equation 7 represents the least squares solution.

These equations hold even if δε is not small, because observation equations are linear in ε.

It should be noted that a smaller number of observations are necessary to solve equation 7, than equation 4. For example, if only timing measurements are available, and the BTS's are not synchronised, then, as noted in U.S. Pat. No. 6,529,165 B1, observations of five common base stations are needed when there are just two radio terminals. However, in this case there are only three unknown parameters (δx, δy, δζ), so only three in-common BTSs are required to solve the equation 5 (except in certain geometrical configuration, such as all the BTSs being co-linear).

In order to evaluate equation 7, it is necessary to have an estimate of the location of the homing device. This does not have to be particularly accurate as in many practical instances, the Jacobian matrix is relatively insensitive to small errors in the estimate of the homing device's location. The estimate of offset in equation 7 can be successively refined as the homing device moves closer to the target.

An example of an algorithm that develops a search route in a particular region, with the aim of finding the target is now described. The aim of the algorithm is to generate a route that has the minimum expected time to find the target. The following is a heuristic algorithm that should approach this objective.
Based on the observations, generate a probability density function (p.d.f.) for the location of the target. There are a number of ways this can be done:
   One approach would be to calculate the covariance matrix for the measurements [J′V⁻¹J]⁻¹ where V is the covariance matrix of the observations. If the errors are Gaussian, then the standard equation for the multi-dimensional Gaussian p.d.f. can be used. In this case the contours of constant probability will be ellipses.
   The covariance matrix approach assumes that the errors are Gaussian distributed. An alternative approach, that does not make this assumption is to use bootstrapping resampling in order to generate an estimate of the p.d.f. Bootstrapping is a standard approach used in the prior art.
Once the p.d.f. has been derived, then the p.d.f. can be overlayed onto a street map of the region of interest. Transform this map into a set of vertices and edges, with the streets corresponding to edges, and the intersections will be vertices. For each edge, integrate the estimate of p.d.f. over the adjacent region in order to assign a probability to that vertice. The adjacent region can be defined in a number of ways but would consist of a simple portion of the area. For example if the region only had parallel roads that were 1000 metres long, and were 50 metres apart, then the integration region for each edge (street) would be a rectangle 50 metres wide, centred on the street, and 1000 metres long.
The problem has now been refined to finding a route along a set of vertices and edges, with a probability assigned to each edge. The aim is to find the search path that minimises the expected distance taken to find the target. This problem formulation is suited to analysis by methods of graph theory. For a small number of roads, the problem can be solved using simple enumeration, for larger number of roads, more efficient methods are needed.

An example of an approach that is more efficient than enumeration is as follows:
If the searcher is outside of the search area, move to the closest street in the search area.
Move to the closest intersection.
At the intersection choose the street which has the highest probability. Continue down that street until the next intersection. If the target is not located, assign a zero probability to the section of street that has just been searched, as the target is clearly not in that street. Continue in this way until the person has been found.
In certain street networks, it is possible that the searcher will reach an intersection with all zero probabilities (because all streets from that intersection have already been searched). In this case, move to the nearest street that has a non-zero probability, and continue as before.
Of course, this algorithm will terminate as soon as the searcher has found the target.

This algorithm will have a relatively short search time, as at every turn, the most probable street is chosen. It will also be exhaustive, every non-zero probability street will be searched.

This algorithm can be simply modified for the case where the homing system is in tracking mode. Once in tracking mode, the probability distribution can be recalculated, taking into account the added information. Then the person doing the tracking will simply choose the most probable street, in view of the additional information.

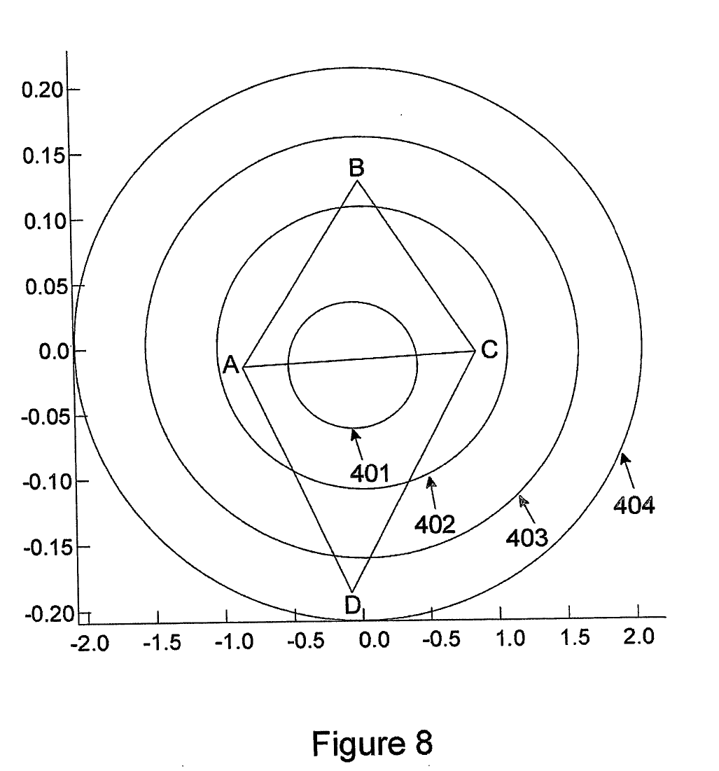

An example of this approach, is shown in FIG. 8, in which the concentric ellipses (401 to 404) represent contours of constant probability. The inner most ellipse 401 represents the highest probability contour, the next largest ellipse 402 represents a lower probability, and so on to the outermost ellipse 404. The straight lines represent roads. Suppose the homing device 20 is starting the search at point A. It can be seen that the target 10 is most likely to be on the arm connecting the points (A,C). The next most likely arm is (A,B,C), and the least likely arm is (A,D,C). In this case, by simple enumeration it can be seen that there are six possible search routes (A,B,C,A,D,C), (A,B,C,D,A,C), (A,C,B,A,D,C), (A,C,B,D,A,C), (A,D,C,A,B,C), (A,D,C,B,A,C). It can be seen that the path that has the shortest expected search time is (A,C,B,A,D,C), because this first traverses the most probable arm, then the next most probable, and finally the least probable.

Applying the search algorithm to this example, suppose the search starts at point A. The arm (or street) with the highest probability will be the one connection (A,C). Accordingly the searcher would be instructed to move along this street until intersection C is reached. At this point the most probable alternative is the arm (C,B,A), so the searcher will be instructed to move along that arm, until the intersection A is reached. At this point the most probable street is (A,D,C), so that will be traversed, so completing a search of the whole area. The search trajectory was (A,C,B,A,D,C), which by simple enumeration is the route that minimizes the expected search time.

This example may also be used to demonstrate how the algorithm applies in tracking. Again assume that the search starts at point A, and is not in tracking mode. Accordingly, the search will move along (A,C). Now assume that as the searcher approaches C, the system changes to tracking mode and calculates a new p.d.f. for the target, based on information gathered from the homing device. Suppose this information results in a higher probability for (C,D,A) arm than the (C,B,A) arm. Accordingly, the searcher will move along the (C,D,A) arm. At the end of this arm, the searcher will then choose the (A,B,C) arm, so completing an exhaustive search.

Display Intercept Route Generally, for public safety reasons, it is best not to intercept a rapidly moving target. In this case it is best to follow the target device 10 at a distance and wait until the target device has ceased movement. Once this has happened the method continues with step calculate p.d.f.

If both the target device and the homing device are moving, then the observations can be filtered to reduce spatially uncorrelated errors such as those due to fast fading using a method that accounts for the movement of the devices. Such filters are well known to those skilled in the art. An example is the Kalman filter. If the network is synchronised or the offsets between the various BTSs are known, then the filtered timing observations can be used to calculate the positions of both the target device and the homing device. Otherwise the signal strength observations can be used in a calculation to obtain lower accuracy estimates of the positions of the target device and the homing device.

A suitable route to the target can be calculated, as described for the Display Route step. The route can then be displayed on the map display 24. As the positions of the homing device 20 and the target device 10 change, suitable updates can be applied to the display of the recommended route. In some circumstances this step will result in the homing device 20 finding the target 10 before it becomes stationary.

A third aspect of the invention, which could improve the second aspect, takes advantage of the fact that the user of the homing device will be moving for a significant proportion of the time while homing in on the target device. While the user is moving the homing device is therefore able to gather independent measurements of the signal attributes that are varying randomly due to processes such as fast fading. By combining these in a standard way, such as a Kalman filter, the homing device can reduce spatially uncorrelated errors in the signal observations and achieve more accurate relative position measurements. If the homing device has an independent positioning capability, it is possible to average the estimates while the homing device is moving. If the homing device moves over a wide area and therefore a wide range of slow fading conditions the accuracy of the averaged estimates will improve.

The context is where both the homing device 20 and the target 10 are capable of making signal observations. Since the homing device 20 will be moving in order to converge on the location of the target, it will have the opportunity to filter or average the observations it is making in order to decrease the effects on the convergence caused by the random variations in the observations that occur in the mobile radio environment.

The following paragraphs give some concrete examples of the application of this idea but should not be interpreted as a comprehensive list of the possible implementations.

It is useful to distinguish between a few cases:
(1) whether the observations are signal levels or timings
(2) whether the homing device 20 has an independent means of measuring its position

Assume first that homing device 20 and target are measuring signal strength only and that the homing device 20 does not possess any independent positioning means. The algorithms being used to direct the hoing device 20 towards the target are operating on the received signal levels, using some model(s) for the attenuation suffered by these signals after they are launched from the BTS antennas. These models include several parameters including the so-called path loss exponent which varies depending on the nature of the environment. In the absence of any other information, the initial values of these parameters would be set to some typical value, representing for instance the vicinity around the strongest cell. As successive observations are made, the signal levels will vary randomly due to shadow (large scale) and fast (small scale) fading. The statistics of these two sources of variation are also modelled in the propagation models used in the homing algorithm. As the homing device 20 moves, the signal level observations it makes will vary randomly due to these two effects as well as more deterministically due to the change in range between the BTS and homing device 20. By observing the degree of variation, the homing device 20 can adjust the values of the corresponding parameters for random variation, in its models. In addition as it moves closer to the target (known for instance by an increase in the number of cells heard in common), the homing device 20 estimated model parameters can also be applied to the model for reception by the target since the closer they are, the greater the likelihood of similar propagation conditions. This similarity may arise for instance if both homing and target devices are in an urban area and the searching process has brought the homing device to the same street as the target. In such environments, in particular for signals originating from microcell BTS antennas it has been shown that the propagation characteristics are dominated by the orientation of the streets in the vicinity. Similarly the large scale fading which arises for instance due to large buildings has been shown to be correlated in some circumstances at distances greater than 100 m. In addition to estimating the statistics of the random parameters, the algorithms also aim to detect the underlying ‘mean’ signal level which reflects the positional information. By filtering the observations while moving over a large area, it is possible to reduce the random variations which occur on both the small and larger scales.

Now assume that the homing device 20 is equipped with an independent positioning facility. The adaption of the model parameters can now be done more intelligently because it is possible to distinguish to an extent between the random variations on a small scale (fast fading) and those on the larger scale. In fact by analysing observations as the homing device 20 approaches a particular cell, the homing device 20 can compute a relatively tight model for the variation in signal level versus range to that cell. If the target is also reporting a level for that cell then it is possible to have a more locally tailored propagation model as a basis for predicting the range between the target and the common cell. A further improvement that can be achieved using the independent position information is that the filtering of the observations can be done more effectively. For instance, using a Kalman Filter, the actual motion of the homing device 20 can be supplied to the filter, enabling it to more effectively isolate the random variations that are not position related.

Now assume that the homing device 20 is measuring signal timings rather than (or in addition to) signal levels. In this case the timings will also be randomly perturbed by multipath as well as non-line of sight. Assuming the simpler homing device 20 configuration, without independent positioning means, the homing device 20 would be able as it moves to observe the degree of variation in the timings (by comparison between cells for instance). This would indicate the degree of multipath in the vicinity and therefore enable the corresponding terms in the algorithm's equations to be tuned appropriately. As with the signal strength measurement, the fact that the homing device 20 is likely to move over a wider area enables the timing observations to be averaged on a wider scale, increasing the likelihood that both small scale multipath and larger scale NLOS errors will be reduced.

Moving to the case where the homing device 20 also has an independent positioning means, the homing device 20 can now distinguish between timing variations that occur on the small scale (due to multipath) and those that occur on the larger scale (more likely to arise due to NLOS). As was the case with the signal level model adaption, the closer the homing device 20 moves to the target (as determined from the common observations), the more the parameters in the model for the target can also be tuned using the knowledge gathered by the homing device 20. As with the signal strength case, the availability of independent positional information, enables the filter to more effectively separate the variations in timing arising from the motion of the homing device 20 and those arising randomly from multipath and NLOS thereby achieving a more accurate estimate of the actual timing.

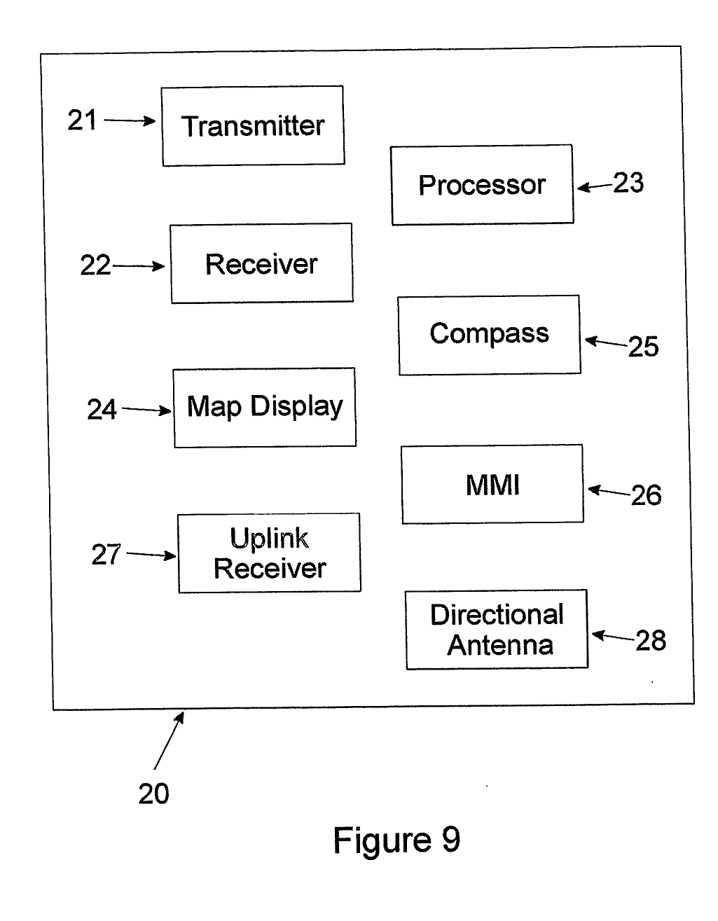

An alternative embodiment will now be described in which the homing device, 20, is modified to provide the capability for direct reception of signals transmitted by the transmitter, 11 in the target device 10. The main elements of the modified homing device are shown in FIG. 9. These include transmitter 21, receiver 22, processor 23, map display 24, compass 25 and MMI 26, all the components of the standard homing device (FIG. 5). In addition an uplink receiver, 27, is provided, having the capability to receive signals originating from the target device transmitter, 11. The modified homing device 20 also includes a directional antenna 28. In this alternative embodiment, the target device 10 is able to send to the homing device 20, via the mobile network, 1, information pertaining to its own transmission including the radio channel parameters. In this manner the uplink receiver, 27 is able to directly obtain observations of the signals transmitted by the target device 10. It should be noted that for the purposes of describing this alternative embodiment, it is assumed that in this radio network, the uplink and downlink frequency bands are distinct necessitating a separate uplink band receiver. Clearly for networks where this was not the case, this uplink reception capability could be provided by the existing receiver, 22.

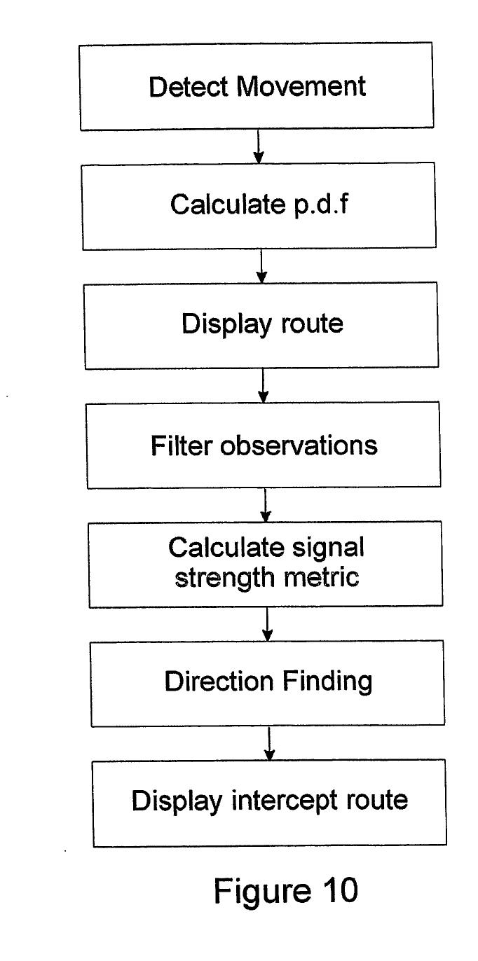

The method of this alternative embodiment is shown in FIG. 10. It includes the first four, and the last step of the previous embodiment (shown in FIG. 7), however it replaces the Calculate Proximity Metric and the Common Mode Differencing steps with new steps, Calculate Signal Strength Metric and Direction Finding. In general terms, the method follows the same procedure as described in FIG. 7 differing only in the way in which the tracking stage is implemented. In particular, instead of using the proximity metric described previously, it computes a different proximity metric using the additional direct measurements of the target device transmissions in addition to the other in-common observations. When the processor, 23, in the homing device 20 decides that the range to the target device 10 is sufficiently small for a high probability of line of sight to the target 10, the homing device 20 then employs the directional antenna 28 to obtain a direct measurement of the bearing to the target 10. The homing device processor 23 does not use the directional antenna until it has a strong indication of line of sight, otherwise it is likely to give an incorrect indication to the user.

In particular it is considered that a directive antenna, in particular the line of bearing (LOB) measurements from it, are not generally useful until there is a line of sight (LOS) path between homing device 20 and target. This is because the signals received at the homing device 20 are likely to have travelled via some indirect path and therefore the angle of arrival measurement would indicate an erroneous direction to the target. However when accompanied by a selection means that determines when the LOB is likely to be reliable and incorporates it into the homing process, this facility could enable more rapid convergence on the target. The following paragraph describes some of the ways in which the determination could be made.

It is well known that multipath propagation results in random variations in the received signal envelope. The statistics of this variation however depend on whether there is a line of sight between the transmitter and receiver. If there is, the envelope variation tends towards a Rician distribution whereas in the absence of such a path the multipath gives rise to a Rayleigh envelope distribution. Therefore the homing device 20 could observe the fading pattern and only use the LOB in the homing process when there is sufficient evidence from the envelope fading of a line of sight path. For a wideband system, for example the UMTS TDD radio access network, further evidence of the availability of a line of sight path could be obtained from the output of a correlator, showing the delay profile of the channel. Additional information is available in the event that the homing device 20 has some knowledge of the power level likely to be transmitted by the target. Measuring the average received signal level at the homing device 20 and computing a path loss prediction would provide further indication on the likelihood of a LOS path.

In the case where the homing device is able to measure the time of arrival of the direct signal from the target, then a further enhancement to this aspect is possible. The enhancement assumes that both the homing device and the target device is able to measure the round trip time to the same BTS. If the timing advance of the target is communicated to the homing device by a standard communications means (e.g. SMS), then it is possible to work out the range from the homing device to the target, the homing device to the common BTS, and the range of the target device to the common BTS. This provides the three sides of a triangle, or sufficient information to make a radial-radial location measurement. This measurement does not provide an absolute position fix, but does provide the relative location of the mobile. This relative location measurement will increase in accuracy as the homing device moves closer to the target. The relative location can be used in a similar fashion to the direction finding antenna to indicate the relative angle to the target (and also the range). In order to use this relative angle information, the User will need to be provided with an orientation, for example by a compass or by asking the user to align the homing device with a particular street.

This alternative embodiment will now be described in more detail by further describing the two new steps.

Signal Strength Metric The homing device's uplink receiver, 27, is able to tune to the radio channel in use by the target device transmitter, 11. The homing device uplink receiver 27 can use means well known in the prior art to measure the received signal strength and time of arrival. If the homing device 20 has current information on the current transmission power level of the target device transmitter 11, the homing device 20 can determine the degree of attenuation in the path from the target 10 to the transmitter. Then, using a suitable empirical model, it can estimate the range to the target 10. If the homing device 20 has a means of measuring the range to the target 10 by use of a timing measurement, then it should work out the range between the homing device and target. If the range can be estimated using timing measurements, then such a range measurement will be preferred to the range inferred from signal strength. However, using methods well known in the art, it could be possible to combine the two estimates into a single estimate of range.

In either case (signal strength or time of arrival), the homing device 20 can then use the calculated range as a metric for determining whether the target device 10 was nearby. There are a number of ways in which this could be done. One simple way is to determine whether the range is below some initiation threshold. If so, then the homing device 20 would be considered to be close to the target device 10. If the measure used indicates that the homing device is in close proximity to the target device, the alternative method of FIG. 9 goes to the Direction Finding step. If on the other hand the metric indicates that the homing device is not yet close to the target device, then the method proceeds to the filter observations step.

Direction Finding There are two possibilities here, the first is if only a signal strength estimate is available, and the second is if a range can be calculated from the time of arrival:—

Signal Strength Only The homing device 20 could indicate to the user, via an audio, textual or graphical prompt, that the device has entered direction finding mode (i.e. tracking mode). In this mode, the directional antenna 28, is switched into the signal path of the homing device's receiver, 22. As well an audible or graphical indication of range (as derived from signal strength) is provided to the User. In a manner that has been described often before in the prior art, the User rotates the homing device with the rigidly attached directional antenna, and by paying attention to the range indication, moves in the direction of minimum range. The method continues in this mode until the target 10 is found, or the range increases above a desist threshold (which might be different from the initiation threshold). Increasing above the desist threshold could be an indication that the homing device 20 is no longer close to the target device 10 in which case the method of the alternative embodiment would revert to the filter observations step.

Range is available from Time of Arrival In this case, as well as the range, the homing device 20 can calculate the relative location of the target 10. This information is then used in a similar fashion as is described in the Common Mode Differencing step, with the range metric used as the proximity metric.

A further aspect of the invention is the provision for the user of the homing device 20 to advise the system 30 of the likely mobility of the target device 10. This additional information would enable particular constraints in the computation of relative position solutions to be tightened, thereby increasing the accuracy of the computation. The application of this aspect can be understood from an example where a law enforcement officer is using the system to home in on mobile subscribers. In one example, the officer might be seeking to apprehend a stolen vehicle by homing in on a mobile installed covertly in the vehicle. In this case the target would be likely to be moving and the officer might not force the homing system to make any assumptions about the mobility of the user allowing it to determine that on the basis of the observations. By contrast if the officer was responding to an emergency call from the victim of a vehicle crash, forcing the system to treat the target as stationary could enable more accurate estimates of absolute or relative positions and therefore a more timely arrival at the scene of the accident.

The invention described herein provides a more effective capability for finding a mobile radio terminal (homing in on it) than the prior art. It is able to do this because it can still find the target in the presence of multipath. In addition, it is able to find the target in cases where near-far interference and/or signal obscuration reduce the number of detectable signals to the point that conventional location systems can no longer operate.

Compared to existing radio homing systems such as [Dop], the invention is able, in its simplest form, to operate with mobile cellular telephones without requiring any hardware modifications, and is able to find such terminals even in challenging suburban and urban areas.

While the above description contains many specificities these should not be construed as limitations on the scope of the invention, but rather as an exemplification of one preferred embodiment thereof. Many other variations are possible within the scope of the claims. For example:

Whilst the Probability Density Function (p.d.f.) is the most likely form for representing the error distribution, it will be appreciated that other suitable representations of the error distribution might be employed. For example, one could use a Cumulative Distribution Function (CDF) or simply selected parameters or moments of the distribution.

The invention could be implemented in remote systems such as Trueposition as an application add on. In this case, the remote positioning system would be instructed to make timing measurements of the target mobile terminal, and the homing device. These measurements would then be used by a central site in the remote system in a similar manner as the preferred embodiment in order to allow the user of the homing device to move to the terminal.

The invention could also be implemented in self-positioning systems such as E-OTD as an application add on. In this case, the mobile terminal in the homing device and the mobile terminal in the target would be instructed to report their timing measurements to a central site. These measurements would then be processed at the central site in a similar manner as the preferred embodiment to allow the user of the homing device to move to the terminal.

The exact sequence of steps in the preferred and alternative embodiment could be varied to still bring about the same effect. For example with multi-tasking system, some of the steps could be performed in parallel.

The system can also improve the performance of Assisted GPS systems. For example, if both the target and the homing device contain AGPS receivers, then the AGPS timings can be used in a similar fashion to the observations described in the preferred embodiment.

The present invention has significant advantages to the existing ways of homing in on mobile terminals.

1. A method for directing a seeker to a target, the method including the steps of:
(a) making one or more observations associated with the target (target observations); and
(b) generating a route based on the one or more observations and estimated error distributions of the one or more target observations.

2. A method according to claim 1 wherein the target is a radio terminal and the target observations are radio signal parameters.

3. A method according to claim 2 wherein the one or more target observations are made by the radio terminal.

4. A method according to claim 2 wherein the one or more target observations are made by a device external to the radio terminal.

5. A method according to claim 2 wherein the one or more target observations are made by both the radio terminal and a device external to the radio terminal.

6. A method according to claim 4 wherein the device external to the radio terminal is a base transceiver station.

7. A method according to claim 1 wherein the one or more target observations are made within a communications network.

8. A method according to claim 1 wherein the estimated error distribution is calculated using a method dependant on a characteristic of the target observations.

9. A method according to claim 2 wherein the estimated error distribution is calculated using a method dependant on a characteristic of the environment of the radio terminal.

10. A method according to claim 1 further including the step of;
(c) determining whether the target is stationary or not and modifying the route accordingly.

11. A method according to claim 1 wherein the location of the seeker is known and is a constraint on the setting of a route to the target.

12. A method according to claim 7 wherein the at least one or more target observations are made within a cellular communications network.

13. A method according to claim 1 further including the step of (c) making one or more observations associated with the seeker (seeker observations).

14. A method according to claim 13 wherein the seeker makes the one or more seeker observations.

15. A method according to claim 14 wherein errors in the target observations and the seeker observations are correlated.

16. A method according to claim 2 wherein the target observations are transmitted to the seeker.

17. A method according to claim 16 wherein the target observations are transmitted to the seeker by the radio terminal.

18. A method according to claim 15 wherein the seeker makes at least one common observation with the target.

19. A method according to claim 18 wherein the seeker controls the observations made by the radio terminal to maximise commonality between the target observations and the seeker observations.

20. A method according to claim 13 wherein the route generated results in reducing a distance between the seeker and the target thus increasing the commonality between the seeker observations and the target observations.

21. A method according to claim 20 wherein once there exist sufficient common observations between the seeker observations and the target observations, the method includes using differences between the common target observations and seeker observations to generate the route to direct the seeker to the target.

22. A method according to claim 2 wherein the one or more target observations include network terminal ID, signal strength and/or timing measurements.

23. A method according to claim 2 wherein the route generated is overlayed on a topographical map of a region containing at least one of the target and seeker.

24. A method according to claim 23 wherein the topographical map includes streets.

25. A system for implementing the method according to claim 1.

26. An apparatus for implementing the method according to claim 1.

27. A homing device for use in the system of claim 24.

28. A method for directing a seeker to a target, the method including the steps of:
(a) making one or more observations associated with the target (target observations); and
(b) generating a route based on the one or more observations and estimated error distributions of those target observations to provide likely locations of the target.

29. A method according to claim 28 wherein the seeker is first directed to the most likely location of the likely locations and then to subsequent most likely of the likely locations.

30. A method according to claim 28 wherein the estimated error distributions are calculated using a probability density function.

31. A method according to claim 29 wherein the seeker has a position capability and is presented with directional information to follow the route.

32. A method according to claim 29 wherein the seeker is presented with information directing the seeker to a first landmark on the generated route, followed by subsequent landmarks along the route once the seeker has arrived at a given landmark.

33. A method according to claim 31 wherein the route includes streets.

34. A method for directing a seeker to a target, the method including the steps of:
(a) making one or more observations associated with the target (target observations);
(b) making one or more observations associated with the seeker (seeker observations); and
(c) generating a route based on a comparison of the one or more target observations and seeker observations and estimated error distributions of those one or more target and seeker observations.

35. A method according to claim 34 wherein the observations include attributes of radio frequency signals around the seeker and the target respectively.

36. A method according to claim 35 wherein the comparison provides directional information to guide the seeker towards the target.

37. A method according to claim 36 wherein the directional information includes direction cosines of a vector between the seeker and the target.

38. A method according to claim 35 wherein the seeker observations and the target observations are made by the seeker and the target respectively.

39. A method according to claim 38 wherein the seeker is directed so as to increase the commonality of the seeker and target observations.

40. A method according to claim 39 wherein the seeker makes observations of the same signals as the target.

41. A method according to claim 40 wherein the seeker instructs the target to make particular observations.

42. A method according to claim 40 wherein the seeker is instructed to make observations of the same signals as the target.

43. A method according to claim 40 wherein upon sufficient commonality between the seeker observations and the target observations, the seeker is directed according to a route determined by using differences between the common target observations and seeker observations.

44. A method according to claim 34 wherein the target is a radio terminal in a radio communications network.

45. A method according to claim 44 wherein the radio communications network is a cellular radio communications network.

46. A method according to claim 34 wherein the seeker is moving and seeker observations are filtered over time to reduce spatially uncorrelated errors in the seeker observations.

47. A method for directing a seeker to a target, the seeker able to receive signals directly from the target to provide direct target observations, the method including the steps of:
(a) making one or more observations associated with the target (target observations);
(b) making one or more observations associated with the seeker (seeker observations); and
(c) generating a route based on a comparison of the one or more target observations, the seeker observations, the direct target observations and estimated error distributions of the at least one or more target and seeker observations.

48. A method according to claim 47 including, upon determining that a sufficient Line of Sight exists between the seeker and the target, determining a Line of Bearing to refine the route.

49. A method according to claim 47 wherein the direct target observations includes field strength measurements.

50. A method according to claim 47 wherein the direct target observations includes time of arrival measurements.

51. A homing device for finding a target, the homing device including:
a receiver for receiving signals surrounding the homing device and for measuring at least one selected attribute of those signals to produce homing device observations; and
an output for providing route information to a user to find the target; wherein
the route information is determined by comparing the homing device observations with target observations derived from measuring at least one selected attributes of signals associated with the target and estimated error distributions of the at least one measured selected attribute of the signals associated with the target.

52. A homing device according to claim 50, wherein the receiver also receives information from a homing system.

53. A homing device according to claim 51 wherein the route information is received from the homing system.

54. A homing device according to claim 51, further including a processor for calculating the route information.

55. A homing device according to claim 51 wherein the output provides the route information in the form of audio information.

56. A homing device according to claim 51 wherein the output provides the route information as visual information.

57. A homing device according to claim 56 wherein the visual information is a map showing the route overlaid on the map.

58. A homing device according to claim 51 further including a compass to provide device orientation information in conjunction with the route information.

59. A homing device according to claim 51 wherein the receiver also receives signals directly from the target to provide direct target observations and wherein the determination of the route information includes the direct target observations.

60. A homing device according to claim 59 further including a directional antenna for obtaining a measurement of a bearing to the target.

61. A homing device according to claim 51 further including a transmitter for transmitting information to the homing system.

62. A homing device according to claim 51 further including a transmitter for transmitting control information to the target.

63. A homing device according to claim 51 wherein the receiver also receives control information from the homing system.

64. A method for directing a seeker to a target, the method including the steps of:
(a) calculating at least one probable location of the target; and
(b) generating a route to direct the seeker to a most probable of the at least one probable locations.

65. A method according to claim 64 wherein a plurality of probable locations is calculated, and wherein the seeker is directed first to the most probable location, followed by subsequent most probable locations, until the target is located.

66. A method according to claim 64 wherein the route is generated to direct the seeker along a minimum distance to the at least one probable location.

67. A method according to claim 28 wherein the route generated takes into account a travel distance to provide a minimum distance for the seeker to travel to find the target.
